(19) United States
(12) Patent Application Publication
(10) Pub. No.: US 2012/0002930 A1
(43) Pub. Date: Jan. 5, 2012

(54) CABLE ASSEMBLY WITH STRAIN RELIEF MEANS

(75) Inventors: HSIEN-CHU LIN, New Taipei (TW); KUN-TE CHENG, New Taipei (TW)

(73) Assignee: HON HAI PRECISION INDUSTRY CO., LTD., New Taipei (TW)

(21) Appl. No.: 13/171,486

(22) Filed: Jun. 29, 2011

(30) Foreign Application Priority Data
Jun. 30, 2010 (TW) 99212363

(51) Int. Cl. G02B 6/44

(52) U.S. Cl. 385/101

(57) ABSTRACT

An cable assembly (100) includes an insulative housing (1); a plurality of terminals (2) combined with the insulative housing; at least one lens (3) mounted to the insulative housing; a cable (4) having a plurality of copper wires (41), a fiber wire (423) and a strength element (43); a cylindrical protective member (6) inserted into an interior of a front segment the cable, with the copper wires, the fiber wire and the strength element extending therethrough, said copper wires electrically connected with the terminals, and the fiber wire optically connected with the fiber; a retaining member having a cylindrical holding portion (51) and the protective member coaxially arranged to clamp the strength element therebetween; and a metallic shell (7) having frame (711) and an accommodating part (712) connected with the frame, the insulative housing enclosed in the frame, and the retaining member received in the accommodating part.

### FIELD OF THE INVENTION

The present invention generally relates to a cable assembly, and more particularly to a cable assembly with a strain relief means for enhancing interconnection between a cable and a connector.

### DESCRIPTION OF PRIOR ART

Many of today's processing systems, such as personal computer (PC) systems, there exist universal serial bus (USB) ports for connecting various USB devices. Some of these USB devices are frequently used by PC users. USB-IF has released several versions for USB standard, i.e., USB Spec V1.0, USB Spec V2.0 and USB Spec V3.0, etc. Transmitting speed is increasing with development of electronic technology. Recently, optical transmitting is also applied to common USB connector so as to expand usage thereof.

For example, CN Pub. Pat. No. 101345358 published on Jan. 14, 2009 discloses an optical USB connector assembly which has a fiber device added to a USB connector assembly. The fiber device has a number of fiber wires connected with lenses embedded in the USB connector. Thus, the optical USB connector can transmit electrical signals and optical signals. However, as the fiber wires are delicate and easily damaged if they are pulled without enough protective measure.

Hence, an improved cable assembly is highly desired to overcome the aforementioned problems.

### SUMMARY OF THE INVENTION

Accordingly, an object of the present invention is to provide a cable assembly with a strain relief means for enhance connection a connector and a cable.

In order to achieve the object set forth, a cable assembly in accordance with the present invention comprises an insulative housing; a plurality of terminals combined with the insulative housing; at least one lens mounted to the insulative housing; a cable having a plurality of copper wires, a fiber wire and a strength element; a cylindrical protective member inserted into an interior of a front segment the cable, with the copper wires, the fiber wire and the strength element extending therethrough, said copper wires electrically connected with the terminals, and the fiber wire optically connected with the fiber; a retaining member having a cylindrical holding portion and the protective member coaxially arranged to clamp the strength element therebetween; and a metallic shell having frame and an accommodating part connected with the frame, the insulative housing enclosed in the frame, and the retaining member received in the accommodating part.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the cable assembly;

FIG. 2 is an exploded, perspective view of FIG. 1;

FIG. 3 is a partially assembled view of the cable assembly; and

FIG. 4 is a cross section view of FIG. 1 taken along line 4-4.

### DETAILED DESCRIPTION OF PREFERRED EMBODIMENTS

Reference will now be made in detail to the preferred embodiment of the present invention.

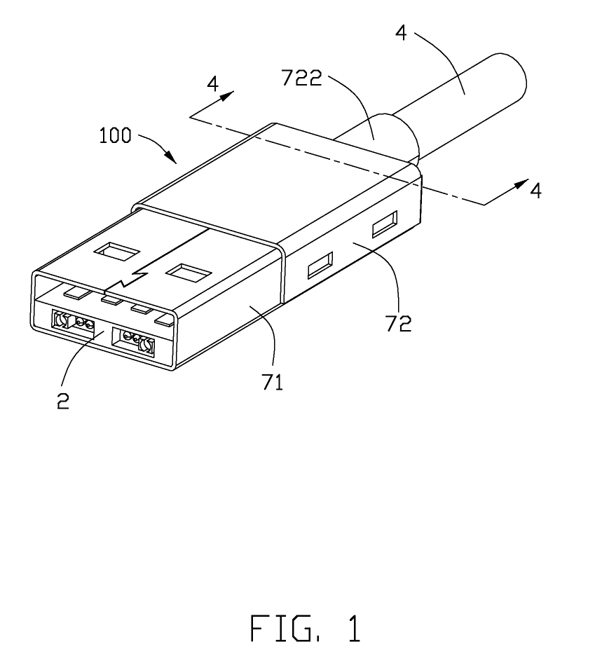

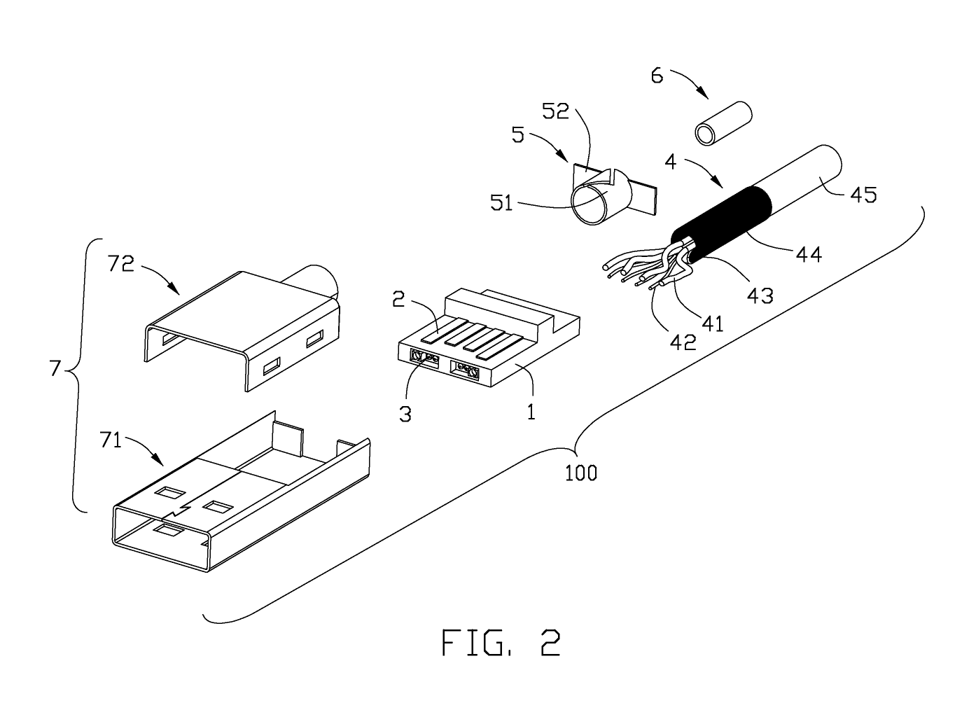

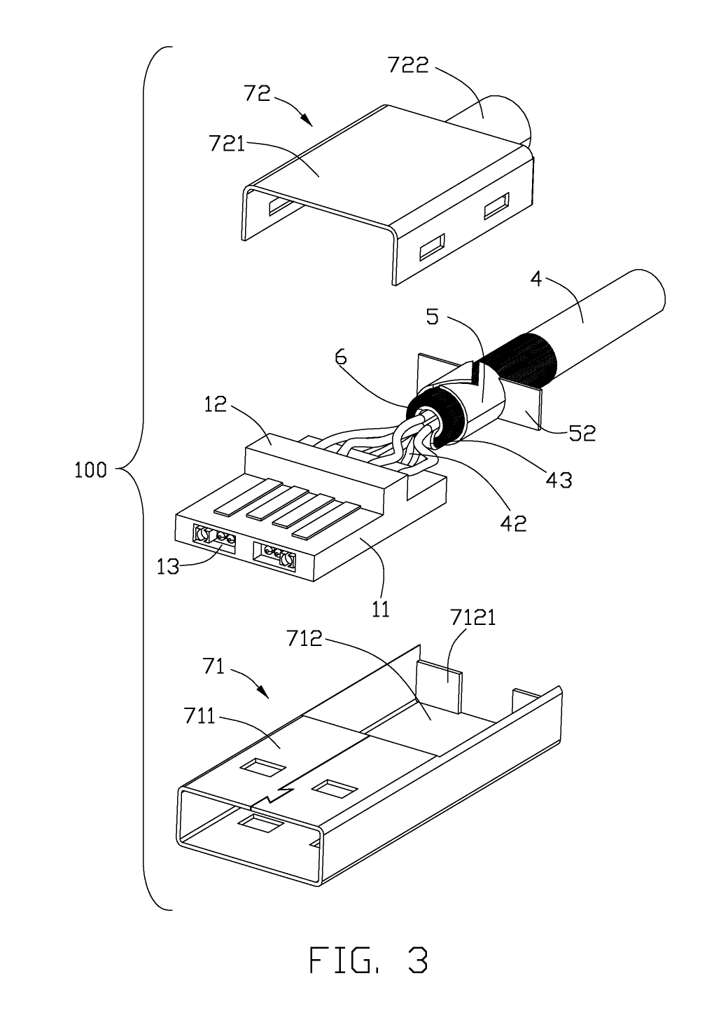

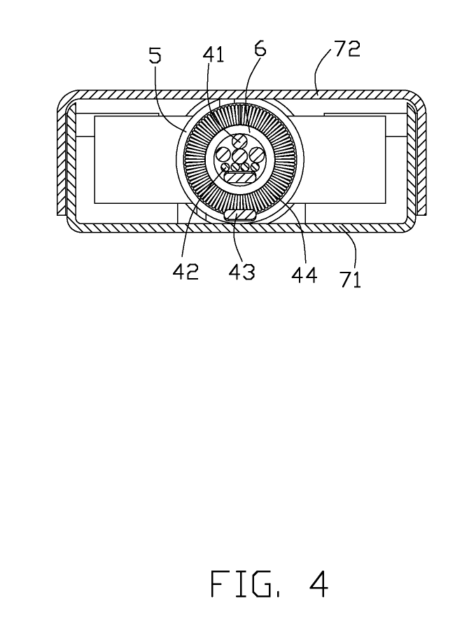

Referring to FIGS. 1-4, a cable assembly 100 in accordance with the present invention comprises an insulative housing 1, a plurality of terminals 2 combined with the insulative housing 1, a number of lenses 3 mounted to the insulative housing 1, a cable 4, a retaining member 5, a protective member 6 and a metallic shell 7.

The insulative housing 1 includes a longitudinal base portion 11, a transversal beam 12 formed on a top side of the base portion 11 and two mounting cavities 13 arranged in juxtaposed manner and recessed backwardly from a front sides of the base portion 11.

There are four of the terminals 2 which are arranged in row along a transversal direction. Arrangement of the terminals 2 is compatible with USB protocol. The terminals 2 are located on a top side of the base portion 11 and further retained by the transversal beam 12.

There are two of the lenses 3 accommodated in each mounting cavity 13. The lenses 3 are disposed proximate to a front edge of the base portion 11.

The cable 4 includes four copper wires 41, four fiber wires 42, at least one strength element 43 associated with the copper wires 41 and the fiber wires 42, a metallic braiding 44 enclosing the copper wires 41, the fiber wires 42 and the strength element 43 and an insulative jacket 45 attached to the metallic braiding 44. The strength element 43 can be kevlar, nylon etc. The copper wires 41 are electrically connected with the terminals 2, respectively. The fiber wires 42 are optically connected with the lenses 3.

The retaining member 5 is made of metallic sheet and includes a cylindrical shaped holding portion 51 and two wing portions 52 laterally extending from a back edge of the holding portion 51. The protective member 6 is also a cylindrical structure, but smaller than the holding portion 51. The protective member 6 is made of metallic material or other hard material. The holding portion 51 and the protective member may be other shaped structure with a passage along a front-to-back direction.

The protective member 6 is inserted into an interior of a front segment of the cable 4, with the copper wires 41, fiber wires 42 and the strength element 43 extending therethrough, then a front segment of the strength element 43 backing up and placed on the metallic braiding 44. The retaining member 5 is mounted to the front segment of the cable 4 and coaxially arranged with regarding to the protective member 6, and the holding portion 51 is deformed to crimp onto the metallic braiding 44 and the strength element 43, thus, the metallic braiding 44 and the strength element 43 are clamped/sandwiched between the protective member 6 and the holding portion 51. In alternative embodiment, the metallic braiding 44, the strength element 43 and the insulative jacket 45 are sandwiched between the protective member 6 and the holding portion 51.

The metallic shell 7 includes a first shell 71 and a second shell 72. The first shell 71 has a rectangular shaped frame 711 and a U-shaped accommodating part 712 connected with the frame 711. There are two blocking portions 7121 spaced apart from each other and projecting upwardly from a back edge of the accommodating part 712. The second shell 72 includes an inverted U-shaped covering part 721 and a crimping part 722 projecting backward from the covering part 721.

The insulative housing 1 is enclosed in the frame 711, and the retaining member 5 is accommodated in the accommodating part 712 and the two wing portions 52 of the retaining member 5 are disposed in front of the two blocking portions 7121 of the second shell 72 and the cable 4 backwardly extends outward via an opening between the two blocking portions 7121. The second shell 72 is assembled to the accommodating part 712 of the second shell 72, and the crimping part 722 grips the cable 4. Thus, the retaining member 5 is held by the first shell 71 and the second shell 72.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly, comprising:
an insulative housing;
a plurality of terminals combined with the insulative housing;
at least one lens mounted to the insulative housing;
a cable having a plurality of copper wires, a fiber wire and a strength element;
a cylindrical protective member inserted into an interior of a front segment the cable, with the copper wires, the fiber wire and the strength element extending therethrough, said copper wires electrically connected with the terminals, and the fiber wire optically connected with the lens;
a retaining member having a cylindrical holding portion and the protective member coaxially arranged to clamp the strength element therebetween; and
a metallic shell having frame and an accommodating part connected with the frame, the insulative housing enclosed in the frame, and the retaining member received in the accommodating part.

2. The cable assembly as recited in claim 1, wherein the cable further includes a metallic braiding enclosing the copper wires, the fiber wires and the strength element.

3. The cable assembly as recited in claim 2, wherein the metallic braiding is sandwiched between the protective member and the holding portion of the retaining member.

4. The cable assembly as recited in claim 2, wherein the strength element is placed on the metallic braiding and collectively clamped between the protective member and the holding portion of the retaining member.

5. The cable assembly as recited in claim 1, wherein the retaining member further has two wing portions laterally projecting from a back edge of the holding portion.

6. The cable assembly as recited in claim 5, wherein there are two blocking portions spaced apart from each other and projecting upwardly from a back edge of the accommodating part.

7. The cable assembly as recited in claim 6, wherein the two wing portions are located in front of the two blocking portions and the cable backwardly extends outward via an opening between the two blocking portions.

8. A cable assembly, comprising:
an insulative housing having a longitudinal base portion with a top side and a front side perpendicular to the top side, at least one mounting cavity recessed backwardly from the front side of the base portion;
a plurality of terminals located on the top side of the insulative housing;
a number of lenses received in the mounting cavity;
a cable having a plurality of copper wires, a number of fiber wires and at least one strength element associated with the copper wires and the fiber wires;
a protective member mounted to a front segment the cable, with the copper wires, the fiber wires and the strength element extending therethrough, said copper wires electrically connected with the terminals, and the fiber wires optically connected with lenses;
a retaining member having a holding portion together with the protective member to clamp the strength element therebetween; and
a metallic shell enclosing the insulative housing and the retaining member.

9. The cable assembly as recited in claim 8, wherein the cable further includes a metallic braiding enclosing the copper wires, the fiber wires and the strength member, the metallic braiding is sandwiched between the protective member and the holding portion of the retaining member.

10. The cable assembly as recited in claim 9, wherein the protective member, the metallic braiding and the holding portion are coaxially arranged.

11. The cable assembly as recited in claim 9, wherein a front part of the strength element is exposed outward the metallic braiding and disposed on the metallic braiding and further sandwiched between the protective member and the holding portion of the retaining member.

12. The cable assembly as recited in claim 8, wherein the strength member is kevlar or nylon.

13. The cable assembly as recited in claim 8, wherein the retaining member further has two wing portions unitarily formed with the holding portion and extending oppositely.

14. The cable assembly as recited in claim 8, wherein there is a transversal beam formed on the top side of the base portion to position the terminals.

15. The cable assembly as recited in claim 8, wherein the metallic shell includes a first shell and a second shell assembled together to hold the retaining member.

16. A cable assembly comprising:
an insulative housing;
a plurality of contacts disposed in the housing;
a plurality of optical elements disposed in the housing;
a cable including a plurality of wires connected to the corresponding contacts, respectively, a plurality of fibers connected to the corresponding optical elements, at least one strength member associated with the wires and the fibers, a braiding surrounding the wires, the fibers and the strength member, and a jacket enclosing surrounding the braiding;
a protective sleeve inserted into the cable within the braiding while surrounding the wires, the fibers and the strength member; and
a retaining sleeve grasping the cable outside of the jacket; wherein the strength member having one inner portion sandwiched between the outer protective sleeve and the inner wires and fibers in a radial direction.

17. The cable connector assembly as claimed in claim 16, wherein the sleeve member further includes an outer portion sandwiched between the retaining sleeve and the jacket.

18. The cable connector assembly as claimed in claim 17, wherein a front portion of the braiding is exposed upon the jacket and backward folded on an outer surface of the jacket, and the outer portion of the strength member is sandwiched between the retaining sleeve and the backward folded braiding in the radial direction.

19. The cable connector assembly as claimed in claim 16, wherein the retaining sleeve further including a pair of wings abutting against a rear wall of a metallic shell, said shell enclosing the housing.
